(19) United States
(12) Patent Application Publication
(10) Pub. No.: US 2017/0271779 A1
(43) Pub. Date: Sep. 21, 2017

(54) POLARIZATION TWIST REFLECTOR FOR MULTIBAND COMMUNICATIONS

(71) Applicant: Samsung Electro-Mechanics Co., Ltd., Suwon-si (KR)

(72) Inventor: Stakanov SERGEY, Suwon-si (KR)

(73) Assignee: Samsung Electro-Mechanics Co., Ltd., Suwon-si (KR)

(21) Appl. No.: 15/298,411

(22) Filed: Oct. 20, 2016

(30) Foreign Application Priority Data
Mar. 17, 2016 (KR) 10-2016-0032217

(51) Int. Cl. H01Q 15/24; H01Q 5/50; H01Q 15/14

(52) U.S. Cl. CPC H01Q 15/242; H01Q 15/14; H01Q 5/50

(57) ABSTRACT

A polarization twist reflector comprising a first groove group and a second groove group. The first groove group is configured to comprise first grooves disposed on a metal plate in a first direction and having a first depth. The second groove group is configured to comprise second grooves disposed on the metal plate in a second direction, orthogonal to the first direction, and having a second depth different from the first depth. The first groove group comprises third grooves disposed on the metal plate in the first direction and having a third depth different from the first depth in a third direction orthogonal to the first direction and the second direction. The second groove group comprises fourth grooves disposed on the metal plate in the second direction and having a fourth depth different from the second depth in the third direction.

### CROSS-REFERENCE TO RELATED APPLICATION

This application claims the benefit under 35 U.S.C. 119(a) of Korean Patent Application No. 10-2016-0032217 filed on Mar. 17, 2016, in the Korean Intellectual Property Office, the entire disclosure of which is incorporated herein by reference for all purposes.

### BACKGROUND

1. Field

The following disclosure relates to a polarization twist reflector for multiband communications which may be applied to a reflector type antenna for multiband communications.

2. Description of Related Art

In general, various types of antenna have been used in the wireless communications field. An example of such an antenna is a reflector type antenna.

Typically, a reflector type antenna may include a twisted reflector for shifting (twisting) high frequency polarization within an operation band. Reflector type antennas have good reflection characteristics for long range communications.

The typical twisted reflector applied to a reflector type antenna for wireless communications may include two grooves orthogonal to each other.

As such, existing twisted reflectors having a single band structure manufactured for single band communications, can only be applied to a reflector type antenna for single band communications.

A twisted reflector used for single band communications cannot be applied to a multiband antenna like a dual band, or the like. As a result, there is a need for a polarization twist reflector used for multiband communications.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a polarization twist reflector, includes a first groove group and a second groove group. The first groove group is configured to include a plurality of first grooves disposed on a metal plate in a first direction. The first groove group has a first depth. The second groove group is configured to include a plurality of second grooves disposed on the metal plate in a second direction. The plurality of second grooves is orthogonal to the first direction, and has a second depth different from the first depth. The first groove group includes a plurality of third grooves disposed on the metal plate in the first direction and has a third depth different from the first depth formed in a third direction orthogonal to the first direction and the second direction. The second groove group includes a plurality of fourth grooves disposed on the metal plate in the second direction and having a fourth depth different from the second depth formed in the third direction.

The first depth of the first groove may be deeper than the second depth of the second groove.

The plurality of third grooves each may have a period and may be disposed between the plurality of first grooves to be parallel to the plurality of first grooves. The third depth of the third groove may be deeper than the first depth of the first groove.

The plurality of fourth grooves may each have a period and may be disposed between the plurality of second grooves to be parallel to the plurality of second grooves. The fourth depth of the fourth groove may be deeper than the second depth of the second groove.

The plurality of third grooves may each have a period and are disposed between the plurality of first grooves to be parallel to the plurality of first grooves. The third depth of the third groove may be deeper than the first depth of the first groove by N*(wavelength/2), where N is a natural number of 1 or greater.

The plurality of fourth grooves may each have a period and may be disposed between the plurality of second grooves to be parallel to the plurality of second grooves. The fourth depth of the fourth groove may be deeper than the second depth of the second groove by M*(wavelength/2), where M is a natural number of 1 or greater.

The first to fourth grooves may have the same width.

In another general aspect, a polarization twist reflector includes a first groove group and a second groove group. The first groove group is configured to include a plurality of first grooves disposed on a metal plate in a first direction and having a first depth, filled with a first material. The second groove group is configured to include a plurality of second grooves disposed on the metal plate in a second direction, orthogonal to the first direction. The plurality of second grooves has a second depth different from the first depth and filled with a second material. The first groove group includes a plurality of third grooves disposed on the metal plate in the first direction. The plurality of third grooves has a third depth different from the first depth and filled with the first material. The second groove group includes a plurality of fourth grooves disposed on the metal plate in the second direction and having a fourth depth different from the second depth and filled with the second material.

The first depth of the first groove may be deeper than the second depth of the second groove.

The plurality of third grooves may each have a period and may be disposed between the plurality of first grooves to be parallel to the plurality of first grooves. The third depth of the third groove may be deeper than the first depth of the first groove.

The plurality of fourth grooves may each have a period and may be disposed between the plurality of second grooves to be parallel to the plurality of second grooves. The fourth depth of the fourth groove may be deeper than the second depth of the second groove.

The plurality of third grooves may each have a period and may be disposed between the plurality of first grooves to be parallel to the plurality of first grooves. The third depth of the third groove may be deeper than the first depth of the first groove by N*(wavelength/2), where N is a natural number of 1 or greater.

The plurality of fourth grooves may each have a period and may be disposed between the plurality of second grooves to be parallel to the plurality of second grooves. The fourth depth of the fourth groove may be deeper than the second depth of the second groove by M*(wavelength/2), where M is a natural number of 1 or greater.

The first to fourth grooves may have the same width. The first material and the second material may have the same dielectric material and may have the same permittivity and magnetic permeability.

The first depth and the second depth may be calculated by the following Equations,

$$d 1 = \frac{1}{k 1} ( arctan \frac{R}{δ 1 * W 1} + p π ) , \\ d 2 = \frac{1}{k 2} ( arctan \frac{R}{δ 2 * W 2} + p π ) ,$$

where d1 is the first depth, d2 is the second depth, p is an integer of 0 or greater, W1 and W2 are calculated from a ratio of permittivities and magnetic permeabilities of the first and second materials, k1 and k2 are respective values calculated from a product of the permittivities and the magnetic permeabilities of the first and second materials, R is a value between 0 and 1, and 61 and δ2 represent normalized width values of the first and second grooves. The third depth and the second depth may be calculated by the following Equations,

$$d 3 = d 1 + N \frac{{λ}_{L 1}}{2} , \\ d 4 = d 2 + M \frac{{λ}_{L 1}}{2} ,$$

where d1 is the first depth, d2 is the second depth, d3 is the third depth, d4 is the fourth depth, is a wavelength of a first band frequency, and N and M are a natural number of 1 or greater.

In another general aspect, a polarization twist reflector includes a first groove group and a second groove group. The first groove group is disposed in a first direction on a metal plate. The first groove group includes a plurality of alternating first groove patterns. A first groove pattern and a second groove pattern of the plurality of alternating first groove patterns each has different depths. The second groove group is disposed in a second direction on the metal plate. The first direction is orthogonal to the second direction. The second groove group includes a plurality of alternating second groove patterns. A first groove pattern and a second groove pattern of the plurality of alternating second groove patterns each has different depths.

The first groove pattern of the plurality of alternating first groove patterns, the second groove pattern of the plurality of alternating first groove patterns, the first groove pattern of the plurality of alternating second groove patterns, and the second groove patterns of the plurality of alternating second groove patterns may each have different depths.

The second groove pattern of the plurality of alternating first groove patterns may have the deepest depth.

The first groove pattern of the plurality of alternating second groove patterns may have the shallowest depth.

Other features and aspects will be apparent from the following detailed description, the drawings, and the claims.

### BRIEF DESCRIPTION OF DRAWINGS

FIG. 1 is a perspective view of an example of a polarization twist reflector for multiband communications.

FIG. 2 is a cross-sectional view of a first groove group of the polarization twist reflector for multiband communications taken along line I-I of FIG. 1.

FIG. 3 is a cross-sectional view of a second groove group of the polarization twist reflector for multiband communications taken along line II-II of FIG. 1.

FIG. 4 is a plan view of an example of the polarization twist reflector for multiband communications of FIG. 1.

FIGS. 5A and 5B are diagrams illustrating phase shifting by a first groove group and a second groove according to an example illustrated in FIG. 1.

FIG. 6 is a characteristics graph illustrating permittivity vs. operation band frequencies offset of the polarization twist reflector of FIG. 1.

FIG. 7 is a characteristics graph illustrating permittivity vs. grooves width of the polarization twist reflector according to an example illustrated in FIG. 1.

FIGS. 8A through 8D are frequency response characteristic diagrams and cross-polarization and co-polarization characteristic diagrams for four operation bands of the polarization twist reflector according to an example illustrated FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

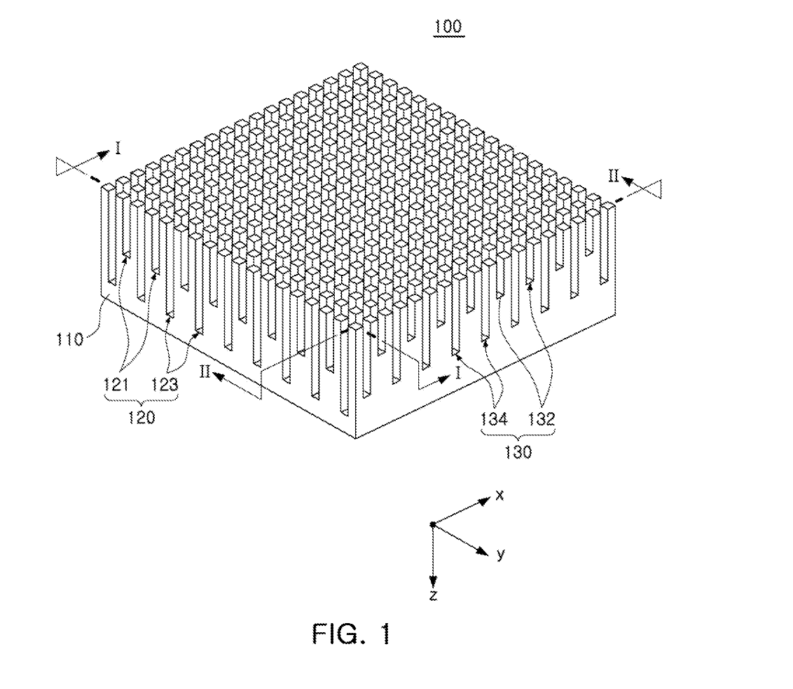

FIG. 1 is a perspective view of a polarization twist reflector for multiband communications according to an example in the present disclosure.

Referring to FIGS. 1-3, a polarization twist reflector 100 for multiband communications according to an example in the present disclosure includes a metal plate 110, a first groove group 120, and a second groove group 130.

The metal plate 110 may be a plate formed of a conductive material.

The first groove group 120 includes a plurality of first grooves 121 formed in one surface of the metal plate 110 in a first direction (for example, an x-axis direction) and having a first depth d1. The plurality of first grooves 121 are disposed to be spaced apart from each other at a preset interval.

The first direction may be the x-axis direction, a second direction may be a y-axis direction, and a third direction may be a z-axis direction. The example in the present disclosure is described based on the above-mentioned example but is not limited thereto. Here, the z-axis direction, the third direction, may correspond to a depth direction of each groove.

The second groove group 130 includes a plurality of second grooves 132 formed in one surface of the metal plate 110 in the second direction (y-axis direction) orthogonal to the first direction and having a second depth d2 different from the first depth d1.

For example, the plurality of second grooves 132 is disposed to be orthogonal to the plurality of first grooves 121 and is disposed to be spaced apart from each other at a preset interval.

The first groove group 120 includes a plurality of third grooves 123 formed in one surface of the metal plate 110 in the first direction (x-axis direction) and having a third depth d3 different from the first depth d1 formed in a third direction (z-axis direction) orthogonal to the first direction (x-axis direction) and the second direction (y-axis direction).

For example, the plurality of third grooves 133 is alternately disposed with the plurality of first grooves 121 in a one-to-one manner, but the disposition of the plurality of third grooves 123 is not limited thereto.

Further, the second groove group 130 includes a plurality of fourth grooves 134 formed in one surface of the metal plate 110 in the second direction (y-axis direction) and having a fourth depth d4 different from the second depth d2 formed in the third direction (z-axis direction).

For example, the plurality of fourth grooves 134 is alternately disposed with the plurality of second grooves 132 in a one-to-one manner, but the disposition of the plurality of fourth grooves 134 is not limited thereto.

As illustrated above, the first groove group 120 includes the plurality of first grooves 121 and the plurality of third grooves 123. The second groove group 130 includes the plurality of second grooves 132 and the plurality of fourth grooves 134. The first groove group 120 and the second groove group 130 allow for multiband operations.

For example, the first depth d1 of the first groove 121 is formed to be larger than the second depth d2 of the second groove 132 and the first to fourth grooves may have the same width.

For example, the first groove 121 and the third groove 123 of the first groove group 120 and the second groove 132 and the fourth groove 134 of the second groove group 130, respectively, may also be formed as an empty space (for example, air).

As another example, the first groove 121 and the third groove 123 of the first groove group 120 are filled with a first material and the second groove 132 and the fourth groove 134 of the second groove group 130 are filled with a second material.

In this case, the first material and the second material are the same dielectric material having the same permittivity and magnetic permeability.

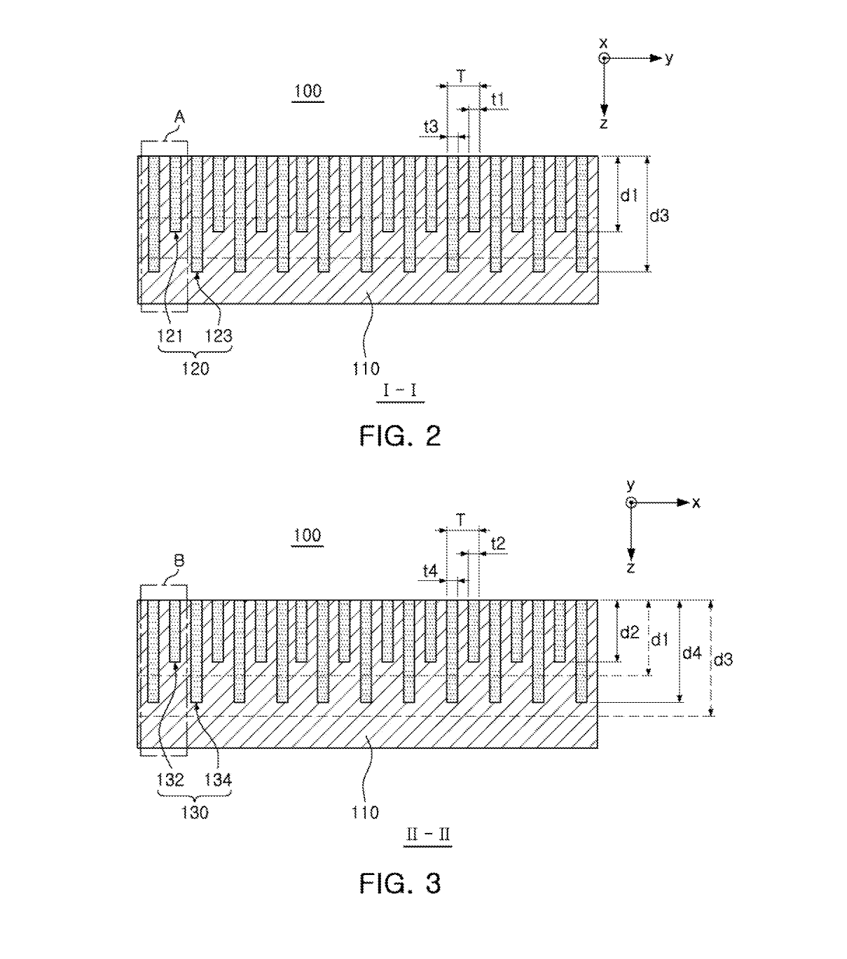

FIG. 2 is a cross-sectional view of a first groove group of the polarization twist reflector for multiband communications according to the example in the present disclosure taken along line I-I of FIG. 1.

Referring to FIGS. 1 and 2, each of the plurality of third grooves 123 has a period T and is disposed between the plurality of first grooves 121 to be parallel to the plurality of first grooves 121.

Here, when the plurality of third grooves 123 are alternately disposed with the plurality of first grooves 121 in a one-to-one manner, the plurality of first grooves 121 each may also be disposed at the same period T as the plurality of third grooves 123.

For example, the third depth d3 of the third groove 123 is deeper than the first depth d1 of the first groove 121.

FIG. 3 is a cross-sectional view of a second groove group of the polarization twist reflector for multiband communications according to the example in the present disclosure taken along line II-II of FIG. 1.

Referring to FIGS. 1 to 3, each of the plurality of fourth grooves 134 has the period T and is disposed between the plurality of second grooves 132 to be parallel to the plurality of second grooves 132.

Here, when the plurality of fourth grooves 134 are alternately disposed with the plurality of second grooves 132 in a one-to-one manner, the plurality of second grooves 132 each may also be disposed at the same period T as the plurality of fourth grooves 134.

For example, the fourth depth d4 of the fourth groove 134 is deeper than the second depth d2 of the second groove 132.

For example, the period T of the first groove group 120 and the period T of the second groove group 130 is the same but the example in the present disclosure is not limited thereto.

Meanwhile, in connection with an incident plane wave, eigen values of an impedance matrix of the twisted reflector are represented by key parameters like the following Equations 1 and 2.
When an electric field vector is parallel to a direction of the second groove,

zₚₐᵣₐₗₗₑₗ=i·w·(δ1·tan kβod1+δ3·tan kβod3) Equation 1
When the electric field vector is perpendicular to a direction of the first groove,

z_{perpendicular}=i·w·(δ2·tan kβod2+δ4·tan kβod4) Equation 2

In the above Equations, βo may represent a wave number of a free space at an operating frequency, k may represent a normalization constant of the wave number βo for the material within the groove, W may represent normalization impedance for the material within the groove, and δi (i=1, . . . , 4) may represent the normalized width of the groove at the period T.

For example, the third depth d3 of the third groove 123 is larger than the first depth d1 of the first groove 121 by N*(wavelength/2), where N is a natural number of 1 or greater and the fourth depth d4 of the fourth groove 134 is larger than the second depth d2 of the second groove 132 by M*(wavelength/2), where M is a natural number of 1 or greater.

For example, the first depth d1 and the second depth d2 are calculated by the following Equations 3 and 4 and the third depth d3 and the second depth d2 are calculated by the following Equations 5 and 6.

$$\begin{matrix}d 1 = \frac{1}{k 1} ( arctan \frac{R}{δ 1 * W 1} + p π ) & Equation 3 \\ d 2 = \frac{1}{k 2} ( arctan \frac{R}{δ 2 * W 2} + p π ) & Equation 4 \\ d 3 = d 1 + N \frac{{λ}_{L 1}}{2} & Equation 5 \\ d 4 = d 2 + M \frac{{λ}_{L 1}}{2} & Equation 6\end{matrix}$$

Further, in connection with the above Equations 3 to 6, widths δ3 and δ4 of the third and fourth grooves may be calculated from the following Equation 7, a relational equation with widths δ1 and δ2 of the first and second grooves and the wanted operation band frequencies offset α may be calculated by the following Equation 8 depending on permittivities ∈1 and ∈2 and magnetic permeabilities μ1 and μ2 of the first and second materials, respectively.

$$\begin{matrix}δ 3 , 4 = δ 1 , 2 \frac{1 - R}{R} & Equation 7 \\ \frac{ɛ 1 , 2}{μ 1 , 2} = {( \frac{δ 1 , 2}{R} )}^{2} {tan}^{2} [ \frac{1}{( α + 1 )} π ] \\ \frac{ɛ 3 , 4}{μ 3 , 4} = {( \frac{δ 3 , 4}{R} )}^{2} {tan}^{2} [ \frac{( α - 1 )}{( α + 1 )} π ] & Equation 8\end{matrix}$$

In Equations 3 to 8, d1 may represent the first depth, d2 may represent the second depth, p may be an integer of 0 or greater, λL1 may be a wavelength of a first band frequency, λL2 may be a wavelength of a second band frequency, δi (i=1, . . . , 4) may be the normalized width of the groove at the period T and may be determined as ‘ti/T’ (i=1, . . . , 4), t may be a period, ti may be the width of the groove, and δ1 and δ2 may represent the normalized width values of the first and second grooves.

Further, W1 and W2 may be normalized impedance (=SQRT(μ/∈)), calculated from a ratio of the permittivities and the magnetic permeabilities of the first and second materials, k1 and k2 may each be the normalization constant of the wave number calculated from a product (=sqrt(μ∈)*(2υ/λL1)) of the permittivities and the magnetic permeabilities of the first and second materials, R may be a value between 0 and 1, a may be the operation band frequencies offset and a ratio (fL2/fL1)(1<α<3) of a first band frequency fL1 and a second band frequency fL2. Further, λ_{L1} may be the wavelength of the first band frequency and N and M may be a natural number of 1 or greater.

According to the above Equation 7, the widths δ3 and δ4 of the third and fourth grooves may be equal to or different from the widths δ1 and δ2 of the first and second grooves.

Further, the period T of the groove and the wavelength λ of the incident wave incident on the polarization twist reflector 100 satisfy the following Equation 9, a conditional equation.

T/λ<<1 Equation 9

In the above Equation 9, the period Tat which the groove is formed may have a very small value, comparing to the wavelength λ of the incident wave. Further, a position and a direction of the polarization twist reflector 100 may be adjusted so that the incident wave is incident while forming an angle of 45° or less with respect to the grooves provided on the metal plate 110 of the polarization twist reflector 100.

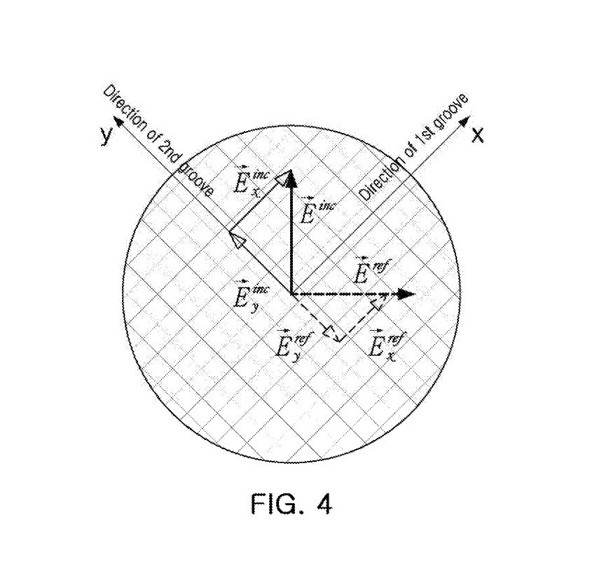

FIG. 4 is a plan view of the polarization twist reflector for multiband communications according to the example in the present disclosure.

Referring to FIG. 4, the twisted reflector according to the example in the present disclosure is manufactured to have various shapes, and for example, may have a circular shape as illustrated in FIG. 4.

In the polarization twist reflector 100 according to the example in the present disclosure, when an incident wave \vec{E}^{inc} at an angle of 45° or less with respect to the first and third grooves of the first groove group 120 provided on the metal plate 110 is incident, the \vec{E}^{inc} may be divided into a \vec{E}ₓ^{inc} component in the first direction (for example, X-axis direction) parallel to the first and third grooves and an \vec{E}_{y}^{inc} component in the second direction (for example, Y-axis direction) perpendicular to the first and third grooves.

For example, when the incident wave \vec{E}^{inc} is a plane wave, a phase of the \vec{E}ₓ^{inc} component in the first direction (for example, X-axis direction) parallel to the first and third grooves leads the incident wave and a phase of the \vec{E}_{y}^{inc} component in the second direction (for example, Y axis direction) perpendicular to the first and third grooves lags behind that of the incident wave, due to the first and third grooves periodically formed.

Therefore, as illustrated in FIG. 4, a vector of a reflected wave \vec{E}^{ref} has a phase difference of 90°, compared to a vector of the incident wave \vec{E}^{inc}. In this case, due to the \vec{E}ₓ^{inc} component in the first direction (for example, X-axis direction) parallel to the first and third grooves and the \vec{E}_{y}^{inc} component in the second direction (for example, Y axis direction) perpendicular to the first and third grooves which are included in the reflected wave \vec{E}^{ref}, the incident wave \vec{E}^{inc} may be twisted as illustrated in FIG. 4.

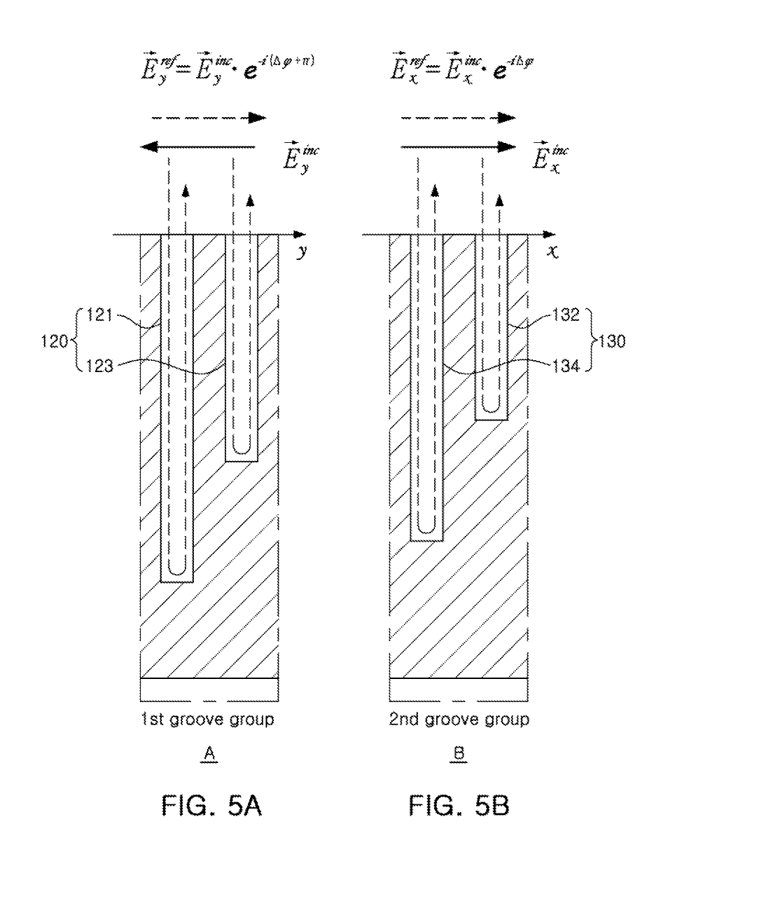

FIGS. 5A and 5B are diagrams illustrating phase shifting due to of the first groove group and the second groove group according to an example in the present disclosure and are respective enlarged views of portion A of FIG. 2 and portion B of FIG. 3.

Referring to FIG. 4 and FIGS. 5A and 5B, if the widths of the grooves of each of the first and second groove groups are smaller than the short wavelength of the operation band, the component \vec{E}_{y}^{inc} of the incident wave in the Y-axis direction may easily pass into the first and third grooves of the first groove group. However, the component \vec{E}_{y}^{inc} of the incident wave in the Y-axis direction does not pass into the second and fourth grooves of the second groove group. The groove may be similar to parallel-plate waveguides for an electric field component, and therefore the electric field component passes into the grooves to be propagated up to the bottom and reflected and the phase shift is acquired in response to the depth of the groove.

Here, as illustrated in FIGS. 5A and 5B, the \vec{E}_{y}^{inc} component is represented by \vec{E}_{y}^{inc}·e^{-i(Δφ+π)} and the \vec{E}ₓ^{ref} component is represented by \vec{E}ₓ^{inc}·e^{-iΔφ}.

The depth of the groove determined by formulas of the present disclosure provides conditions and an electric field component Ey in the y-axis direction has a phase shifted by approximately 180° with respect to an electric field component Ex in the x-axis direction.

Therefore, in four bands, phase shifts Δφ1, Δφ2, Δφ3, and Δφ4 depend on the following Equation 10.

$$Δ ϕ 1 = β o \cdot 2 \cdot d 1 \\ Δϕ 3 = β o \cdot 2 \cdot d 3 = β o \cdot 2 \cdot ( d 1 + λ / 2 ) = 2 \frac{π}{λ} ( d 1 + \frac{λ}{2} ) = Δ ϕ 1 + 2 π = Δ ϕ 1 \\ Δϕ 2 = β o \cdot 2 \cdot d 2 = β o \cdot 2 \cdot ( d 1 + λ / 4 ) = 2 \frac{π}{λ} ( d 1 + \frac{λ}{2} ) = Δ ϕ 1 = π \\ Δϕ 4 = β o \cdot 2 \cdot d 4 = β o \cdot 2 \cdot ( d 3 + λ / 4 ) = 2 \frac{π}{λ} ( d 3 + \frac{λ}{2} ) = \frac{2 π}{λ} ( d 1 + \frac{3 λ}{4} ) = Δ ϕ 1 + π \qquad Equation 10$$

Meanwhile, by analyzing key parameters vs. target operation frequency band offset α of the twisted reflector structure according to the example of the present disclosure, a formula (please refer to Equation 8) for structural parameters of the twisted reflector calculation may be provided, in which the polarization twist effect may be acquired in an interest operation band.

By analyzing parameters vs. target main operation frequency band offset α, it may be appreciated that many combinations for the normalized width of the groove may be present and the reflector which may be actually implemented for a kind of appropriate filling material may be provided.

However, for example, one efficient case is a case in which the two groove groups have the same width and are filled with the same material.

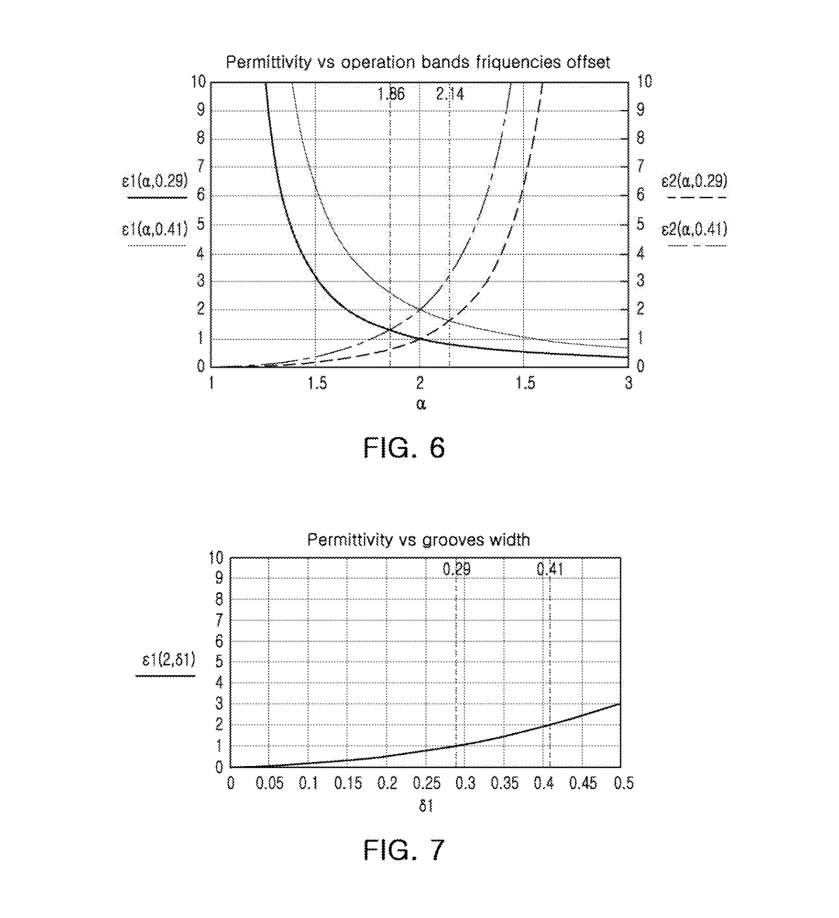

In connection with this, two graphical solutions will be described with reference to FIGS. 6 and 7.

FIG. 6 is a characteristics graph illustrating permittivity ∈ vs. operation band frequencies offset α of the polarization twist reflector for multiband communications according to the example in the present disclosure and FIG. 7 is a characteristics graph illustrating permittivity vs. grooves width of the polarization twist reflector for multiband communications according to the example in the present disclosure.

Four intersecting points in four graphs illustrated in FIGS. 6 and 7 provide 4 variants of the structural parameters for the twisted reflector. The two intersecting points may be an intersecting point for the case in which α, the main operation frequency, band offset is 2 (α=2) and the other two intersecting points may be an intersecting point for the case in which α, the main operation frequency, band offset is different as α=1.86 and α=2.14. The last two variant widths of the twisted reflector according to the example in the present disclosure may be different. For example, in the case of α=1.86, δ1=δ3=0.29 and δ2=δ4=0.41 and in the case of α=2.14, δ1=δ3=0.41 and δ2=δ4=0.29

Therefore, in connection with the above-mentioned parameters, to realize the simplest and most appropriate scheme, substantially unlimited selection sets for combinations of parameters securing the target operation frequency offset and object may be present.

For example, to provide the target operation bands, the same width of the grooves for the two groove groups is selected.

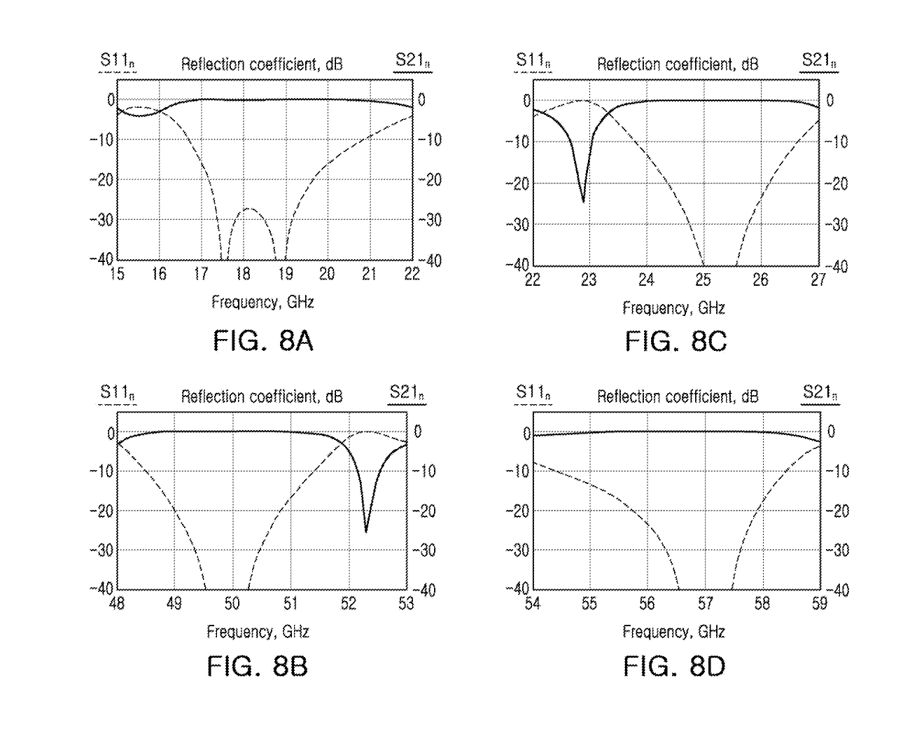

FIGS. 8A through 8D are frequency response characteristic diagrams for four operation bands of the polarization twist reflector for multiband communications according to the example in the present disclosure.

The frequency response characteristic diagrams illustrated in FIGS. 8A through 8D show simulation data for different frequency bands, in connection with the twisted reflector in the case in which the first depth d1 of the first groove may be 2 mm, the second depth d2 of the second groove may be 4 mm, the third depth d3 of the third groove may be 14 mm, and the fourth depth d4 of the fourth groove may be 16 mm.

Referring to the frequency response characteristics graphs of FIGS. 8A through 8D, it is appreciated that pass characteristics S11 and removal characteristics S21 are excellent in different operation frequencies bands, that is, frequency bands of 17 to 19 GHz illustrated in FIG. 8A and 25 to 26 GHz illustrated in FIG. 8B, 49 to 50 GHz illustrated in FIG. 8C, and 56 to 57 GHz illustrated in FIG. 8D, and as a result it is appreciated that the twisted reflector according to the example in the present disclosure may show the appropriate performance in the multiband.

As set forth above, according to the examples in the present disclosure, the polarization twist reflector for multiband communications may include the new groove structure which may support the multiband, such that the polarization twist reflector for multiband communications is applied to the reflector type antenna for multiband communications and may acquire the multiband operation.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A polarization twist reflector, comprising:
a first groove group configured to comprise first grooves disposed on a metal plate in a first direction and having a first depth; and
a second groove group configured to comprise second grooves disposed on the metal plate in a second direction, orthogonal to the first direction, and having a second depth different from the first depth,
wherein the first groove group comprises third grooves disposed on the metal plate in the first direction and having a third depth different from the first depth in a third direction orthogonal to the first direction and the second direction, and
the second groove group comprises fourth grooves disposed on the metal plate in the second direction and having a fourth depth different from the second depth in the third direction.

2. The polarization twist reflector of claim 1, wherein the first depth of the first grooves is deeper than the second depth of the second grooves.

3. The polarization twist reflector of claim 1, wherein the third grooves each have a period and are disposed between the first grooves to be parallel to the first grooves, and
the third depth of the third grooves is deeper than the first depth of the first grooves.

4. The polarization twist reflector of claim 1, wherein the fourth grooves each have a period and are disposed between the second grooves to be parallel to the second grooves, and
the fourth depth of the fourth grooves is deeper than the second depth of the second grooves.

5. The polarization twist reflector of claim 1, wherein the third grooves each have a period and are disposed between the first grooves to be parallel to the first grooves, and
the third depth of the third grooves is deeper than the first depth of the first grooves by N*(wavelength/2), where N is a natural number of 1 or greater.

6. The polarization twist reflector of claim 1, wherein the fourth grooves each have a period and are disposed between the second grooves to be parallel to the second grooves, and
the fourth depth of the fourth grooves is deeper than the second depth of the second grooves by M*(wavelength/2), where M is a natural number of 1 or greater.

7. The polarization twist reflector of claim 1, wherein the first to fourth grooves have the same width.

8. A polarization twist reflector, comprising:
a first groove group configured to comprise first grooves disposed on a metal plate in a first direction and having a first depth, filled with a first material; and
a second groove group configured to comprise second grooves disposed on the metal plate in a second direction, orthogonal to the first direction, and having a second depth different from the first depth and filled with a second material,
wherein the first groove group includes third grooves disposed on the metal plate in the first direction and having a third depth different from the first depth and filled with the first material, and
the second groove group includes fourth grooves disposed on the metal plate in the second direction and having a fourth depth different from the second depth and filled with the second material.

9. The polarization twist reflector of claim 8, wherein the first depth of the first grooves is deeper than the second depth of the second groove.

10. The polarization twist reflector of claim 8, wherein the third grooves each have a period and are disposed between the first grooves to be parallel to the first grooves, and
the third depth of the third grooves is deeper than the first depth of the first groove.

11. The polarization twist reflector of claim 8, wherein the fourth grooves each have a period and are disposed between the second grooves to be parallel to the second grooves, and
the fourth depth of the fourth grooves is deeper than the second depth of the second groove.

12. The polarization twist reflector of claim 8, wherein the third grooves each have a period and are disposed between the first grooves to be parallel to the first grooves, and
the third depth of the third grooves is deeper than the first depth of the first grooves by N*(wavelength/2), where N is a natural number of 1 or greater.

13. The polarization twist reflector of claim 8, wherein the fourth grooves each have a period and are disposed between the second grooves to be parallel to the second grooves, and
the fourth depth of the fourth grooves is deeper than the second depth of the second grooves by M*(wavelength/2), where M is a natural number of 1 or greater.

14. The polarization twist reflector of claim 8, wherein the first to fourth grooves have the same width, and
the first material and the second material are the same dielectric material and have the same permittivity and the same magnetic permeability.

15. The polarization twist reflector of claim 8, wherein the first depth and the second depth are calculated by the following Equations,
$$\begin{matrix}d 1 = \frac{1}{k 1} ( arctan \frac{R}{δ 1 * W 1} + p π ) , \\ d 2 = \frac{1}{k 2} ( arctan \frac{R}{δ 2 * W 2} + p π )\end{matrix}$$
where d1 is the first depth, d2 is the second depth, p is an integer of 0 or greater, W1 and W2 are calculated from a ratio of permittivities and magnetic permeabilities of the first and second materials, k1 and k2 are respective values calculated from a product of the permittivities and the magnetic permeabilities of the first and second materials, R is a value between 0 and 1, and δ1 and δ2 represent normalized width values of the first and second grooves.

16. The polarization twist reflector of claim 15, wherein the third depth and the second depth are calculated by the following Equations,
$$\begin{matrix}d 3 = d 1 + N \frac{{λ}_{L 1}}{2} , \\ d 4 = d 2 + M \frac{{λ}_{L 1}}{2}\end{matrix}$$
where d1 is the first depth, d2 is the second depth, d3 is the third depth, d4 is the fourth depth, λ_{L1} is a wavelength of a first band frequency, and N and M are a natural number of 1 or greater.

17. A polarization twist reflector, comprising:
a first groove group disposed in a first direction on a metal plate, the first groove group comprising alternating first groove patterns, a first groove pattern and a second groove pattern of the alternating first groove patterns each having different depths; and
a second groove group disposed in a second direction on the metal plate, the first direction orthogonal to the second direction, the second groove group comprising alternating second groove patterns, a first groove pattern and a second groove pattern of the alternating second groove patterns each having different depths.

18. The polarization twist reflector of claim 17, wherein the first groove pattern of the alternating first groove patterns, the second groove pattern of the alternating first groove patterns, the first groove pattern of the alternating second groove patterns, and the second groove patterns of the alternating second groove patterns each have different depths.

19. The polarization twist reflector of claim 18, wherein the second groove pattern of the alternating first groove patterns has the deepest depth.

20. The polarization twist reflector of claim 19, wherein the first groove pattern of the alternating second groove patterns has the shallowest depth.
